(19) United States
(12) Patent Application Publication
(10) Pub. No.: US 2026/0311255 A1
(43) Pub. Date: Oct. 8, 2026

(54) SYSTEM AND METHOD FOR DETECTING MANIPULATION IN INTERACTION

(71) Applicant: Nice Ltd., Ra'anana (IL)

(72) Inventors: Samarth JOSHI, Pune (IN); Rakesh BHOSALE, Pune (IN); Nikhil Jivanrao RUDRAKAR, Pune (IN)

(73) Assignee: Nice Ltd., Ra'anana (IL)

(21) Appl. No.: 19/171,865

(22) Filed: Apr. 7, 2025

(51) Int. Cl. G06Q 40/06; G06F 40/242; G06F 40/279

(52) U.S. Cl. CPC G06Q 40/06; G06F 40/242; G06F 40/279

(57) ABSTRACT

A system and method for detecting manipulation in an interaction, including: receiving text of the interaction; analyzing the text of the interaction to detect manipulative content; and generating a report summarizing the detected manipulative content. In some embodiments analyzing the text may include checking for predefined patterns using a static dictionary. In some embodiments analyzing the text may performing dynamic analysis using a language model.

### FIELD OF THE INVENTION

The present invention relates to the field of detecting manipulations in interactions, and more particularly, to methods to identify manipulation and undue influence of a financial advisor on investment decisions of a customer.

### BACKGROUND OF THE INVENTION

Conversations in the form of interactions (e.g. communications between people recorded as audio, video, text, etc. or some combination of modes) may include language indicating a problem, possible legal issue, or other issues that an organization may want to identify. It is desirable to automate such review of interactions. Regulations in financial markets mandate that financial advisors uphold certain ethical standards and practices when offering advice to clients. For example, financial advisors should consider the risk tolerance of the client and make sure that the proposed investment aligns with that risk tolerance. Thus, if an advice provided by a financial advisor to the client does not align with the risk tolerance to which the client agrees, the advice is considered unsuitable. In some cases, financial advisors that encourage clients to invest in an investment that is associated with a risk factor that is higher than the risk tolerance of the investor, tend to perform manipulation on the investor towards that investment.

Some firms deploy technology to ensure that their financial advisors comply with these regulations. Typically, the technology used only focuses on limited aspects to ascertain suitability. This may prevent the tools used today from discovering a variety of non-compliance issues.

### SUMMARY OF THE INVENTION

According to embodiments of the invention, a computer-based system and method for detecting manipulation in an interaction may include receiving text of the interaction; analyzing the text of the interaction to detect manipulative content; and generating a report summarizing the detected manipulative content.

According to some embodiments of the invention, analyzing the text may include checking for predefined patterns using a static dictionary.

According to some embodiments of the invention, analyzing the text may include performing dynamic analysis using a language model.

According to some embodiments of the invention, analyzing the text may include performing contextual analysis using the language model to provide a context-based explanation for why a certain content is manipulative.

According to some embodiments of the invention, the language model may include a bidirectional encoder representations from transformers (BERT) language model trained on a labeled dataset comprising text labeled as manipulative and text labeled as non-manipulative.

Some embodiments of the invention may include generating a manipulation score based on the analysis.

Some embodiments of the invention may include stopping the interaction if the manipulation score exceeds a threshold.

Some embodiments of the invention may include generating an alert if the manipulation score exceeds a threshold.

Some embodiments of the invention may include checking if a trade exists for an entity involved in the interaction; and blocking the trade if the manipulation score exceeds a threshold.

Some embodiments of the invention may include presenting the text of the interaction on a display; and highlighting the manipulative content on the presented text.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIG. 1 is a block diagram of an exemplary computing device which may be used with embodiments of the present invention.

FIG. 2 is a block diagram of a system for detecting manipulation in an interaction, according to some embodiments of the present invention.

FIG. 3 is a flowchart of a method for detecting manipulation in an interaction, according to some embodiments of the invention.

FIG. 4 is a block diagram of system for evaluating trades based on a level of manipulation detected in an interaction, according to embodiments of the invention.

FIG. 5 is a flowchart of a method for evaluating trades based on a level of manipulation detected in an interaction, according to some embodiments of the invention.

FIG. 6 illustrates an example data center system, in accordance with at least one embodiment.

FIG. 7 is an example of a screenshot of a graphical user interface displaying results of a method for detecting manipulative content in an interaction, according to embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Some regulations in financial markets may mandate that financial advisors (referred to herein also as agents) consider the suitability of the investor (also referred to herein as a client or a customer) before making financial recommendations, and the advisors are required to practice ethical sales practices. Firms deploy technology to ensure they comply with these regulations. For example, technology is used to verify that investment advice provided by a financial advisor during the interaction aligns with the risk tolerance to which the investor agrees. If it doesn't, the investment advice may be considered unsuitable. Other solutions simply verify that required disclosures were made by the financial advisor during the interaction, e.g., that certain content was provided to the investor. This practice is widely accepted today. Some systems used for compliance verification only focus on limited aspects to ascertain suitability, such as checking risk tolerance scores. The limitation of this approach is that it does not factor in how much the financial advisor has influenced the client. Some rule-based systems exist today that aim at detecting noncompliance. However, those rule-based systems provide insufficient coverage of all possible use cases.

Furthermore, current compliance systems do not have the capability to link a specific interaction, or an interaction that includes manipulative content, with risky transactions or trades. As compliance is seen as a cost, firms do not invest heavily in innovation but rather rely on off-the-shelf products to make compliance efficient while keeping the costs low.

Embodiments of the invention may detect manipulations that occurred during the investment advisory process either through voice or written communication, by detecting manipulative content using generative AI. Embodiments of the invention may monitor the communication channels between an agent (e.g., a financial advisor) and a client (e.g., an investor) to establish whether the agent has unlawfully persuaded or manipulated the client to make a new trade or hold on to the existing transaction. Furthermore, embodiments of the invention may improve interaction analysis technology and analyze actual transaction or trade data to establish a link between such communications and an actual transaction or trade on the client's portfolio. Once a determination is made, any other non-compliance issues flagged on the transaction, e.g., the transaction does not align with the risk tolerance to which the client agrees, may carry additional importance as evidence suggesting that the advice to the client was deliberately misleading. Knowing whether an agent has persuaded a client to get into the risky investment or recommended the client to hold onto risky investment may help in conforming with the rules and regulations enforced in financial markets.

Embodiments of the present invention may provide a system and method for detecting manipulation in an interaction, for example for detecting manipulation made by a financial advisor in order to influence a client. Embodiments of the invention may include extracting the text of an interaction between the financial advisor and the client, analyzing the text of the interaction to detect manipulative content, and generating a report summarizing the detected manipulative content and other relevant information. Analyzing the text of the interaction may include checking for predefined patterns using a static dictionary and/or performing dynamic analysis using an artificial intelligence (AI) model such as a generative AI model, a language model or a large language model (LLM). The analysis may further include performing contextual analysis using the AI model to provide a context-based explanation for why a certain content is manipulative. The AI model may include the bidirectional encoder representations from transformers (BERT) language model trained on a labeled dataset including text labeled as manipulative and text labeled as non-manipulative. Other models may be used.

AI and language analysis technology may be improved by embodiments of the present invention, for example via the use of predefined patterns, a static dictionary, contextual analysis, and/or other features. By using AI models, embodiments of the invention may improve the technology of manipulation detection in interactions.

The analysis may be performed online or offline. Action may be taken if manipulative content is detected online or offline. For example, when manipulative content is detected online, a supervisor may be added to the interaction, an alert or a notice may be presented online to the client, the agent and/or to a supervisor, suggesting that manipulative content has been detected, or the interaction may be stopped or halted. Some embodiments of the invention may include checking if a trade exists for an entity involved in an interaction, e.g., the client side of the interaction, for interactions in which manipulative content has been detected. If such trade is detected, the trade may be temporarily or permanently blocked. For example, the trade found to be linked to a party to an interaction may be stopped or not authorized, a notice describing the manipulative content may be presented to the client, and only if the client provides a consent again, the trade may be allowed and performed. Some embodiments may include presenting the text of the interaction to a user on a display, e.g., to the agent, to the client and/or to a supervisor, and highlighting the manipulative content on the presented text.

An interaction may be a conversation or exchange of information between two or more people, for example between a speaker, a caller, a customer, a client or an investor, and a financial advisor or an agent. The interaction may also be performed in writing via any applicable communication channel, e.g., email, chat, WhatsApp, etc. An interaction may be for example a telephone call, a videotelephony or videoconferencing meeting, or voice over Internet Protocol (VoIP) call, etc. An interaction may describe both the event of the conversation and also the data associated with that conversation, such as an audio recording of the conversation, a text or transcript of the interaction, and metadata. Metadata describing an interaction may include information beyond the exchange itself: metadata may include for example the telephone number of the investor (e.g. gathered via ANI, automatic number identification), an internet protocol (IP) address associated with equipment used by the investor, account information relevant to or discussed in the interaction, the purported name or identification (ID) of the client, audio information related to the interaction such as background noise, duration of the recording, bitrate of the recording, file properties, and other information.

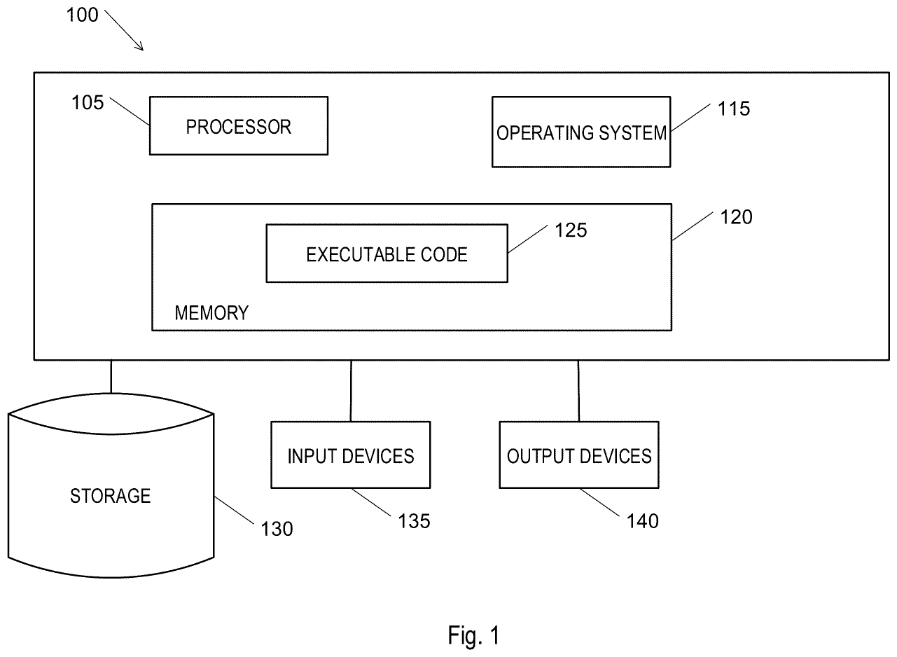

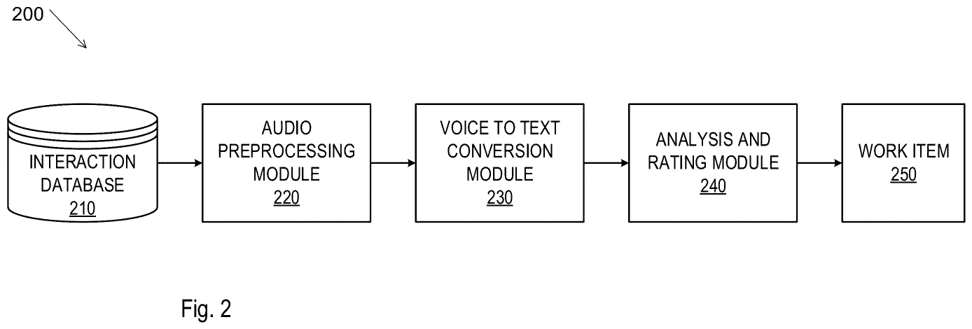

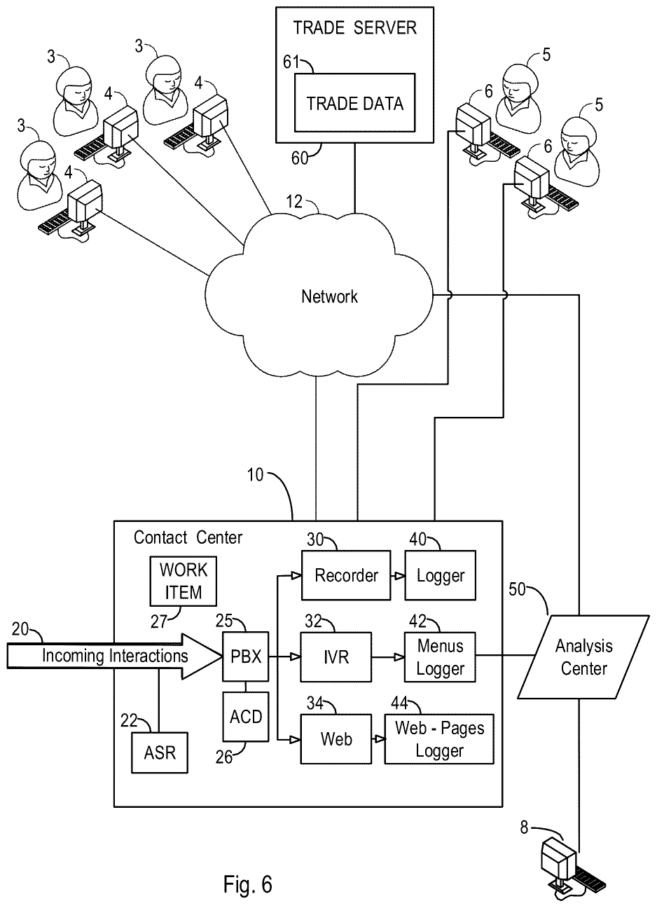

Reference is now made to FIG. 1, which is a block diagram of an exemplary computing device which may be used with embodiments of the present invention. Computing device 100 may include a controller or processor 105 that may be or include, for example, logic, one or more central processing unit processor(s) (CPU), one or more graphics processing unit(s) (GPU), one or more data processing unit(s) (DPU), one or more application-specific integrated circuits (ASICs), one or more field programmable arrays (FPGAs), one or more integrated circuits (ICs), a system-on-chip (SoC), a chip or any suitable computing or computational device, an operating system 115, a memory 120, a storage 130, input devices 135 and output devices 140. Each of modules and equipment shown in FIGS. 2 and 6 such as system 200 and analysis center 50, may be or include a computing device such as included in FIG. 1, although various units among these entities may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a random access memory (RAM), a read only memory (ROM), a dynamic RAM (DRAM), a synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of possibly different memory units. Memory 120 may store for example, instructions to carry out a method (e.g., code 125), and/or data such as user responses, interruptions, etc.

Executable code 125 may be any executable code, e.g., software or firmware, an application, a program, a process, task or script. Executable code 125 may be executed by processor 105 possibly under control of operating system 115. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by for example executing software or code. Storage 130 may be or may include, for example, a hard disk drive, a floppy disk drive, a compact Disk (CD) drive, a CD-recordable (CD-R) drive, a universal serial bus (USB) device or other suitable removable and/or fixed storage unit. Data, simulation data, may be stored in a storage 130 and may be loaded from storage 130 into a memory 120 where it may be processed by processor 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card, a modem, printer or facsimile machine, a universal serial bus (USB) device or external hard drive may be included in input devices 135 and/or output devices 140.

Embodiments of the invention may include one or more article(s) (e.g., memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Reference is now made to FIG. 2, which is a block diagram of a system 200 for detecting manipulation in an interaction, according to embodiments of the invention. Elements and modules of FIG. 2, such as audio preprocessing module 220, voice to text conversion module 230 and analysis and rating module 240 may be or may be executed by a computer system such as shown in the example of FIG. 1 or by contact center 10 and analysis module 50 shown in the example of FIG. 6. It is noted that system 200 is an example only, and other computer systems may detect manipulation in an interaction according to embodiments of the invention.

Data such as interaction data, e.g., audio recordings, text or text transcriptions and metadata of interactions, may be recorded and stored in interaction database 210. Interaction database 210 may be implemented in storage 130. The metadata may include for example, a client ID, an agent ID, a time of the interaction and any other interaction data as required and/or other data. In some embodiments, detecting manipulation in an interaction may be performed offline, e.g., audio processing module 220 may obtain, receive or read interaction data of interactions that have ended and were stored in interaction database 210. In some embodiments, detecting manipulation in an interaction may be performed online, e.g., audio processing module 220 may obtain interaction data of ongoing interactions, and results of the manipulation detection, e.g., the manipulation score, the manipulative text, etc. may be stored in interaction database 210, e.g., as part of the metadata of the interaction.

Audio preprocessing module 220 may obtain, receive, fetch or read interaction data, from interaction database 210 when working offline or from other sources such as PBX 25 when working online. Audio preprocessing module 220 may perform preprocessing of the interaction audio. Preprocessing may include filtering, noise reduction, or segmentation and other preparation tasks required for preparing the audio of the interaction for audio to text conversion.

Audio preprocessing module 220 may initiate the process of manipulation detection by creating a request to retrieve interaction audio recording from interaction database 210, connect to interaction database 210 or to other recording server to download the audio files including the interaction audio, handle tasks such as audio enhancing, formatting and preparing the audio data for further processing and performing noise reduction by filtering out unwanted noise from the recordings to improve clarity.

Voice to text conversion module 230 may extract the text of the interaction. Voice to text conversion module 230 may include a speech-to-text engine that may perform audio to text conversion, transcription or automatic test recognition (ASR), e.g., transcribe the preprocessed audio into text, in a format suitable for analysis. If the audio files are compressed, voice to text conversion module 230 may uncompress the audio files, e.g., convert the audio files from a compressed format such as MP3 to an uncompressed format such as waveform audio file format (WAV) prior to the transcription. Voice to text conversion module 230 may provide the transcribed text to analysis and rating module 240. In case of a written interaction (e.g., a WhatsApp or other text chat, email exchange, etc.), analysis and rating module 240 may obtain, receive, fetch or read interaction text directly from interaction database 210. Analysis and rating module 240 may analyze the text of the interaction to detect manipulative content.

Analysis and rating module 240 may perform a static analysis, e.g., analyze the text of the interaction by checking for predefined patterns using a static dictionary, a dynamic analysis using a generative AI model such as a language model, or a combination thereof. The static analysis may include extracting keywords and phrases from the interaction text and checking for predefined patterns or flagged terms using the static dictionary. For example, the extracted words may be compared against a predefined list of words and phrases that are marked or labeled as manipulative in the static dictionary to identify manipulative, sensitive, or significant terms.

The dynamic analysis may include employing an AI-based analysis model for context-specific word evaluations and analyzing the context of extracted words using Generative AI to detect potential manipulations. Analysis and rating module 240 may combine the results of the static and dynamic analyses to generate a final manipulation detection output. Analysis and rating module 240 may flag or label sensitive or confidential terms discovered in the manipulation text (either in the static or dynamic analysis).

Analysis and rating module 240 may further perform a contextual analysis using the AI based language model to provide a context-based explanation for why a certain content is manipulative. In some embodiments, the language model used for detecting manipulative content and for performing the contextual analysis may be BERT (language model) trained on a labeled dataset comprising text labeled as manipulative and text labeled as non-manipulative.

According to some embodiments, detecting manipulative content by analysis and rating module 240 may include the following steps, performed, for example, by BERT (not all steps are mandatory, and other steps may be used):
1. Preprocessing, including for example:
   Stop words removal: removing unimportant words (like “the”, “a”, etc.).
   Lowercasing: converting the text to lowercase to ensure consistency.
   Special character removal: removing punctuation or special characters, as they generally don't contribute much to the analysis.
2. Tokenizing—the text may broken into smaller units, typically words or sub-words, known as tokens. An example of using BERT tokenizer may include:
   Input Text: “Trust me, this stock is a great investment!”
   Tokenized Text: [‘trust’, ‘me’, ‘,’, ‘this’, ‘stock’, ‘is’, ‘a’, ‘great’, ‘investment’, ‘!’]
These tokens may then be mapped into unique token IDs. This mapping process may convert human-readable text into a numerical format, so that BERT can process it.
3. BERT embeddings and attention mechanism:
   Input embeddings: each token may be transformed into a latent vector or embedding, that may capture the semantic meaning of the token.
   Self-attention: BERT may use a self-attention mechanism to evaluate the relationships between some or all words in the sentence, even if they are far apart. For example, the word “trust” in “Trust me” is not analyzed in isolation to be a phrase positively related to trust, since in the context of the entire sentence, “Trust me” may be a manipulative phrase. BERT may capture contextual nuances, recognizing that “trust” might be used manipulatively in a first sentence, while being neutral or positive in another sentence.
4. Fine-tuning for manipulative language detection: further training or fine-tuning BERT on a specific dataset that includes labeled manipulative and non-manipulative sentences (e.g., a labeled dataset of persuasive sales calls, stock market manipulation, or financial news articles). Fine-tuning may adjust the model's weights to focus on detecting manipulative language, learning patterns such as:
   Appeals to authority: “I'm an expert, so you should trust me.”
   Urgency: “You must act now, or you'll miss this opportunity.”
   Exaggeration: “This is a once-in-a-lifetime investment opportunity.”
During fine-tuning, BERT may learn to associate specific words and word combinations with manipulative language.
5. Prediction and classification: after fine-tuning, the model may be capable of classifying new input text as either:
   Manipulative, suggesting the presence of manipulation tactics such as urgency, appeal to authority, or exaggeration.
   Non-Manipulative, where the text does not contain these tactics and is neutral or objective.
The classification may be based on patterns BERT has learned from the fine-tuned data, where certain phrases and word combinations, e.g., “trust me,” “act now”, are likely to signal manipulation.
If BERT classifies the input as manipulative or as containing manipulative content, an notice may be provided to the user, suggesting why the text was classified as manipulative. The generating the notice may include:
   Marking words that appeal to trust: words such as “trust” or “believe” may be used to establish authority.
   Marking words that create a sense of urgency: phrases such as “act now” or “limited offer” may create a sense of urgency to influence decision-making.
   Marking words that relate to overstatement: using extreme adjectives or superlatives such as “best,” “once-in-a-lifetime,” etc.
If the text is classified as non-manipulative, a notice may be provided to the user, suggesting that the language is neutral and doesn't include tactics meant to influence or pressure the reader into making a decision.
6. Performing contextual analysis: this step may include generation of an explanation, e.g., using generative AI. For example, the detected manipulative content, e.g., words and phrases, may be provided to a generative AI model that is trained to provide explanations or prompted to explain why these words and phrases are manipulative. The system may provide a context-based explanation for why a sentence or phrase is manipulative. For example:
   Example text: “Trust me, this stock is a great investment.”
   Explanation: the phrase “Trust me” is a manipulative appeal, trying to gain the reader's trust without providing evidence. The word “great” is an exaggerated adjective that may influence decision-making.
The explanation may be tailored based on the context in which the words are used. For example, “trust me” may not always be manipulative; it depends on the broader context (e.g., persuasive or manipulative intent).
7. Output the sentiment and analysis, e.g., as part of work item 250 or in a report provided by the system. the report or work item may include the following:
   Sentiment classification: a classification suggesting whether the text is manipulative or non-manipulative.
   Contextual explanation: a dynamic explanation of why the text is classified in that way, detailing the specific manipulative tactics detected.

Analysis and rating module 240 may rank, rate or grade the level of manipulative content detected in the interaction audio by assigning a manipulation score to the interaction, e.g., in a scale from 0-10, where 0 represents no manipulative content detected, and 10 represents the highest level manipulative content possible. The ranking may be based on the detected manipulative content. In some embodiments, ranking may be performed using an AI model to evaluate the overall level of manipulation based on the detected manipulative content. In some embodiments the manipulation score may be evaluated against one or more thresholds to classify the analyzed interaction as manipulative or non-manipulative, or to a manipulation level, e.g., non-manipulative, manipulation suspected, manipulative.

Analysis and rating module 240 may generate work item 250 or a report summarizing the interaction metadata, the detected manipulative content, manipulation score and classification, and/or a task list generated based on the detected manipulative content. Work item 250, generated by analysis and rating module 240, may include the following (not all of the following items are mandatory, and other items may be included in work item 250):
Metadata and details about the interaction and analysis results, e.g., manipulation score, interaction classification (e.g., manipulative or non-manipulative or any other classification used), results of the contextual analysis, etc.
The interaction text, with the manipulative content marked or highlighted.
A decision related to the interaction, e.g., if the manipulation score exceeds a threshold, the decision may be to either block the interaction, e.g., to prevent further processing of the interaction, to report the interaction, e.g., to a supervisor, for tracking or further manual review. If the recording does not exceed the threshold, the decision may be to forward the interaction, e.g., to other systems, for standard processing. Other decisions related to the interaction may be included in work item 250.
A decision related to a possible trade entered by the client participating in the interaction. For example, if the manipulation score exceeds a threshold, the decision may be to block or suspend trade requests entered by the client participating in the interaction, or the decision may be to block or suspend trade requests entered by the client participating in the interaction, if the requested trade is associated with a risk factor that is above a threshold or above the risk tolerance of the client. Other decisions related to a possible trades entered by the client participating in the interaction may be included in work item 250.

Work item 250 may be used by other systems, e.g., in contact center 10, to perform an action as dictated by the decision, e.g., to block the interaction if classified as manipulative or process the interaction if classified as non-manipulative. Items from work item 250 may be presented to a user, e.g., the agent, the client or a supervisor. For example, the text of the interaction may be presented on a screen or a display (e.g., using output devices 140), together with the manipulation score, the manipulation classification, and with the manipulative text highlighted.

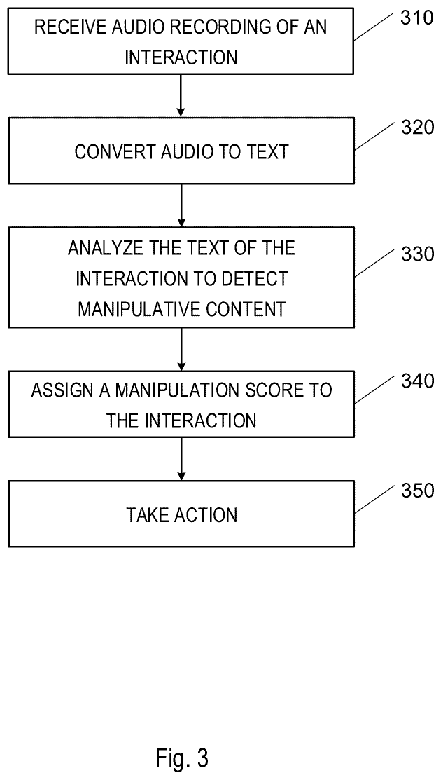

Reference is now made to FIG. 3, which is a flowchart of a method for detecting manipulation in an interaction, according to some embodiments of the invention. The operations of FIG. 3 may be performed using a computing device, such as the computing devices described with respect to FIGS. 1, 2 and 6, but other systems may be used.

In operation 310, a processor (e.g., processor 105 depicted in FIG. 1 executing code to carry out the method for detecting manipulation in an interaction according to embodiments of the present invention) may obtain, receive, fetch or read an audio recording of an interaction. The interaction may include a conversation between an agent, e.g., a financial advisor, and a client, e.g., a potential investor. The processor may preprocess the audio by enhancing, formatting and preparing the audio data for further processing and by filtering out unwanted noise from the recordings to improve clarity. If the interaction is a written interaction, operation 310 may receive, fetch or read the text of the interaction, and preprocessing may not be required. In operation 320, the processor may convert the audio recording to text using any applicable transcription tool. If the interaction is a written interaction, operation 320 may be omitted. In operation 330, the processor may analyze the text of the interaction to detect manipulative content. The processor may perform static analysis, dynamic analysis, or a combination thereof. The static analysis may include detecting words and phrases related to manipulation in the text of the interaction based on a static dictionary, e.g., a dictionary of terms that are known to be manipulative. The statice dictionary may be prepared offline by language aspects and used to find specific and predefined terms. Some example terms may include “confident”, “fail”, “success”, “Trust me” etc. The dynamic analysis may be performed by providing the text of the interaction to a generative AI model trained for the task of detecting manipulative content, such as an LLM or BERT. The processor may further perform a contextual analysis using the generative AI model to provide a context-based explanation for why a certain content is manipulative. In operation 340, the processor may assign a manipulation score to the interaction, based on the analysis performed in operation 330. The processor may generate the manipulation score using any applicable method, for example, using a generative AI model that may receive the manipulative text detected in operation 330, and any other relevant data, and may generate a manipulation score based on the input. The processor may further classify the interaction to manipulative or non-manipulative (or to other classifications) based on the manipulation score, e.g., by comparing the manipulation score to one or more thresholds, or using any other applicable method. In some embodiments the manipulation score and/or classification are directly related to the number of occurrences of manipulative words or phrases. An example for manipulation score and classification based on the number of occurrences of manipulative words or phrases is presented in Table 1. Other classifications may be used.

TABLE 1
An example for manipulation score and classification based on
the number of occurrences of manipulative words or phrases

| # of occurrences of | | |
|---|---|---|
| manipulative words or | Manipulation | |
| phrases | score | Classification |
| 0 | 0 | No manipulation |
| 1-2 | 3 | Mild manipulation |
| 3-5 | 6 | Moderate manipulation |
| 6 or above | 10 | High manipulation |

In operation 350, the processor may take action based on the manipulation score and classification. For example, the processor may inform, e.g., by sending a push notice, one or more of the participants of the interaction that manipulative content has been detected. For example, a notice may be sent to the agent as a warning sign to stop using manipulative content, to the client, as a warning that the client may be subject to manipulation from the agent, and/or to a supervisor that may take a corrective action, e.g., join the interaction, stop the interaction or send educational material to the agent regarding rules and regulations for preventing using manipulations in interactions. If the analysis of the interaction is performed online, e.g., if the interaction is ongoing, the processor may stop or disconnect the interaction if the manipulation score exceeds a certain threshold. The processor may further present the results of the manipulation detection analysis on a display. For example, the processor may present the text of the interaction, with the manipulative content highlighted, possibly together with the manipulation score assigned to the interaction, the contextual data and other metadata.

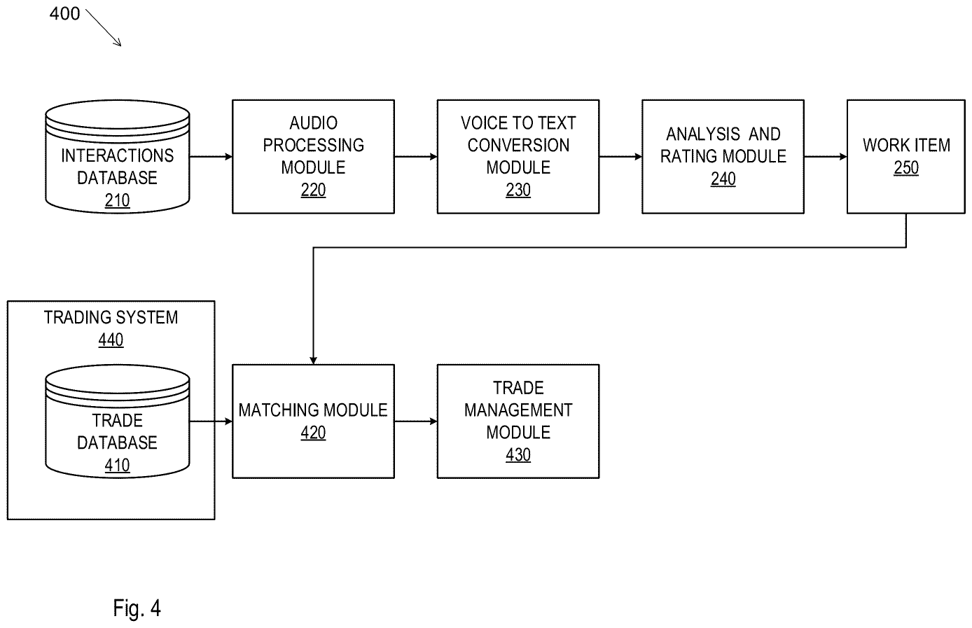

Reference is now made to FIG. 4, which is a block diagram of a system 400 for evaluating trades based on a level of manipulation detected in an interaction, according to embodiments of the invention. Elements and modules of FIG. 4, such as audio matching module 420, and trade management module 430 may be or may be executed by a computer system such as shown in the example of FIG. 1 or contact center 10 and analysis module 50 shown in the example of FIG. 6. It is noted that system 400 is an example only, and other computer systems may evaluate trades based on a level of manipulation detected in an interaction, according to embodiments of the invention. Some elements in system 400 may be similar to respective elements in system 200. Those elements are given the same reference numeral and will be described again.

System 400 may combine system 200 for detecting manipulation in an interaction with a trading system 440 or with a trade database 410. Trading system 440 may include trade database 410 that may store trade history and/or trade requests. For example, trade database 410 may store trade history or trade requests entered by clients participating in the interactions analyzed by system 200 (or possible investors served by contact center 10 such as customers 3).

Matching module 420 may obtain work item 250 and trading data from trade database 410. Matching module 420 may match or link client data from work item 250 (e.g., an ID or other identification data related to the client participating in the analyzed interaction) and the client data in trades or trades requests stored in trade database 410. If a match is found, e.g., if matching module 420 has concluded that a certain trade or trade request in trade database 410 is associated or linked with a certain interaction or a certain work item 250, then it may be concluded that a client that has been exposed to manipulative content in an interaction with a financial advisor, has placed a trade or a trade request in trading system 440 following the interaction. In such cases, an appropriate action may be taken, for example, trade management module 430 may block or suspend the interaction. For example, trade management module 430 may block or suspend the interaction if work item 250 includes a decision to block or suspend transaction requests entered by the client participating in the interaction. If the requested trade is associated with a risk factor that is above a threshold, then trade management module 430 may evaluate the risk factor of the requested trade, and if the risk factor of the requested trade is above the threshold included in work item 250 (or associated with the client in any other manner) than trade management module 430 may block or suspend the trade. The requested trade may be refused altogether, or suspended until further investigation is made. For example, the requested trade may be placed on hold until another interaction, with a different agent, is performed with the client, to verify that the client understand the trade or transaction and is truly interested. Thus, embodiments of the invention may improve the technology of trading systems by enabling automatic suspension or disapproval of trades based on interaction analysis.

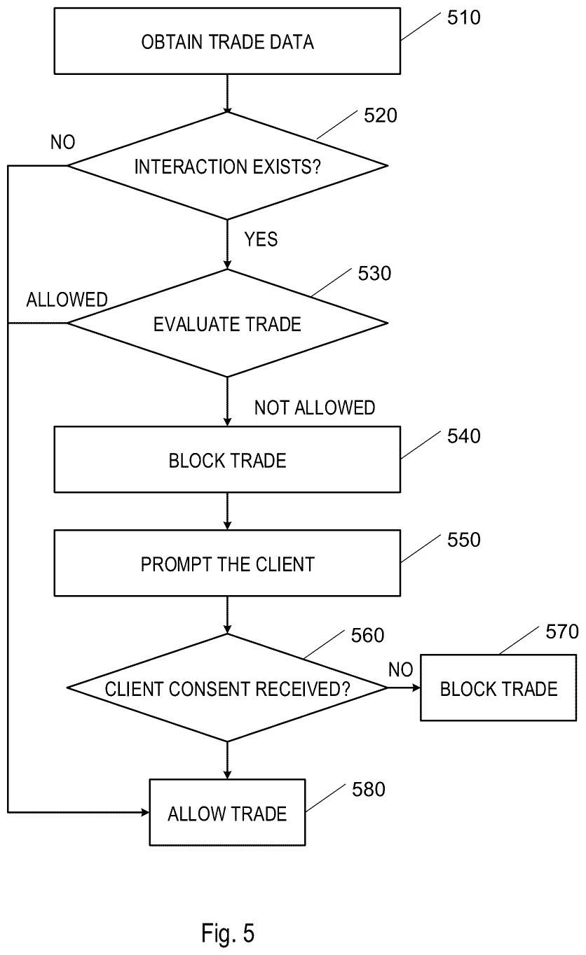

Reference is now made to FIG. 5, which is a flowchart of a method for evaluating trades based on a level of manipulation detected in an interaction, according to some embodiments of the invention. The method may be performed using a computing device, such as the computing devices described with respect to FIGS. 1, 2 and 6, but other systems may be used.

In operation 510, a processor (e.g., processor 105 depicted in FIG. 1 executing code to carry out the method for evaluating trades based on a level of manipulation detected in an interaction according to embodiments of the present invention) may obtain, receive or fetch trade data. The trade data may include any applicable information related to the trade, including data identifying the client (e.g., a trader or an investor) placing the trade, such as client ID, a risk tolerance associated with the client, and data related to the trade itself, e.g., the trade direction, amount, risk level, etc. In operation 520, the processor may check if an interaction exists (e.g., recorded) between the client placing the trade and an agent (e.g., a financial advisor) in a certain time window before the trade request is placed. If such interaction is not found then the processor may allow the trade, as indicated in operation 580. If an interaction exists, the processor may analyze the interaction to detect manipulative content as disclosed herein, or fetch a work item that was already generated for the interaction. In operation 530, the processor may evaluate the trade against the analysis results in order to determine whether to block or allow the trade. For example, if no manipulative content is detected in the interaction, or if a manipulation score associated with the interaction equals or is below a threshold, then the processor may allow the trade. However, if manipulative content is detected in the interaction, or if a manipulation score associated with the interaction is above a threshold, then the processor may not allow the trade. The processor may take into account other parameters related to the trade, the client and the interaction. For example, the processor may evaluate the risk factor of the requested trade against a risk tolerance associated with the client, and perform the above analysis only if the risk factor of the requested trade is higher than the risk tolerance associated with the client. Other factors may be taken into account and other logic may be implemented in operation 530.

If the trade is not allowed in operation 530, then in operation 540 the processor may block or suspend the trade. The trade may be blocked completely or temporarily. If the trade is temporarily blocked, then in operation 550 the processor may prompt the client, e.g., by sending the client a warning message indicating that the client might have been exposed to a manipulation form the agent, with relevant details regarding the detected manipulative content such as the manipulative text detected, the manipulation score assigned to the interaction, etc. In operation 560, the client may or may not provide his consent to the trade, following the warning notice. If the client provides consent, then the trade may be allowed, as indicated in operation 580. If, however, the client does not give consent following the warning notice, the trade may be permanently blocked, as indicated in operation 570. It is noted that the method presented in FIG. 5 is exemplary only, and other methods for evaluating trades with relation to manipulative content detected in interactions may be performed, for example, if manipulative content is detected in an interaction related to a trade, a notice may be sent to a supervisor that may initiate another interaction with the client to further discus the trade. Other actions may be taken.

FIG. 6 is a block diagram of a system for detecting manipulation in an interaction and for evaluating trades based on the manipulation content detected, according to embodiments of the present invention. While FIG. 6 shows such a system in the context of a contact center, embodiments of the invention may be used in other contexts. Contact center 10 may include any facility or system server suitable for receiving and recording communications from clients or customers. Such contact communications may include, for example, telephone calls, facsimile transmissions, e-mails, web interactions, voice over IP (“VoIP”), video, etc. Various specific types of communications contemplated through one or more of these channels may include, without limitation, email, SMS data (e.g., text), tweet, instant message, web-form submission, smartphone applications, social media data, and web content data (including but not limited to internet survey data, blog data, microblog data, discussion forum data, and chat data), etc. In some embodiments, the communications may include contact tasks, such as taking an order, making a sale, responding to a complaint, etc. In various aspects, real-time communication, such as voice, video, or both, may be included. It is contemplated that these communications may be transmitted by and through any type of telecommunication device and over any medium suitable for carrying data (e.g., over network 12). For example, the communications may be transmitted by or through telephone lines, cable, or wireless communications.

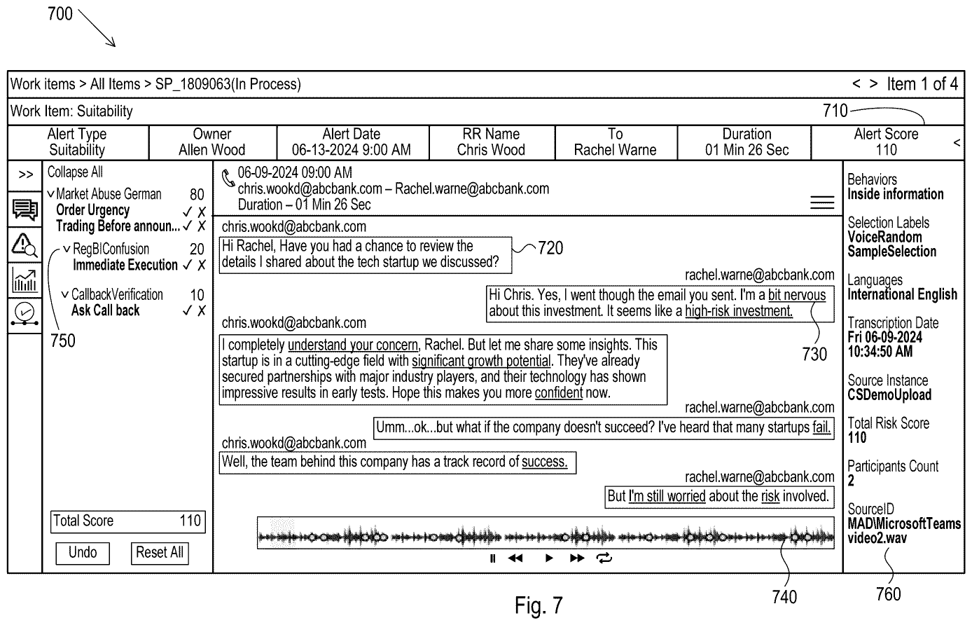

Incoming interactions 20, e.g., conversations, telephone calls, interactive voice response (IVR) interactions, etc., among people 3, e.g., customers or clients, and agents 5 may enter a contact center 10 and be routed for example by a private branch exchange (PBX) 25 and/or automatic call distributer (ACD) 26 or other equipment to relevant systems, such as IVR block or processor 32, Internet sessions or web block 34 and voice interactions block or recorder 30. People 3 may operate external user equipment 4 to communicate with agents 5 via contact center 10; and agents 5 may operate agent terminals 6 for that communication and other purposes. Agent terminals 6 may be configured to present work items 250, interaction data (e.g., as presented in FIG. 7), and other content to agents, according to embodiments of the invention. The work items 250 may be presented to the agents on a display, as part of a graphical user interface (GUI). Incoming interactions 20 may be pre-processed and may enter the system as text data, or may be converted to text via automatic speech recognition (ASR) module 22. User terminals 8 may be operated for example, by a supervisors and/or managers. User terminals 8 may provide data regarding manipulative content detected in interaction, e.g., work items 250, interaction data (e.g., as presented in FIG. 7), to supervisors and/or managers, according to embodiments of the invention.

User equipment 4, agent terminals 6, user terminals 8 and trade server 60 may include computing or telecommunications devices such as personal computers or other desktop computers, conventional telephones, cellular telephones, portable or tablet computers, smart or dumb terminals, etc., and may include some or all of the components of a computer system shown in FIG. 1.

Interaction data or documents may be stored, e.g., in files and/or databases, e.g., in storage 130. For example logger 40, menus logger 42, and web-page logger 44 may record information related to interactions, such as the content or substance of interactions (e.g. recordings and/or transcripts of telephone calls) and metadata (e.g. telephone numbers used, customer IDs, etc.). In the case that documents other than interactions are used, other databases may be used. The data from contact center 10 may be output, sent or exported to an analysis center 50, which may be part of contact center 10, or external to and/or remotely located from contact center 10.

One or more networks 12 may connect equipment or modules not physically co-located, for example connecting external user equipment 4 to contact center 10, and contact center 10 to analysis center 50. Networks 12 may include for example telephone networks, e.g., such as a public switched telephone network (PSTN), the Internet, or other networks. While in FIG. 6 contact center 10 is shown passing data to analysis center 50, these modules may communicate via a network such as networks 12. Networks 12 may further connect between trade server 60, user equipment 4, agent terminals 6, analysis center 50 and contact center 10.

Web block 34 may support web interactions over the Internet (e.g., operate web pages which may be executed in part on user equipment), IVR block 32 may provide menus and other information to customers 3 and for obtaining selections and other information from customers 3, and recorder 34 may process or record voice sessions with customers 3. It may be appreciated that contact center 10 presented in FIG. 1 is not limiting and may include any blocks and infrastructure needed to handle voice, text, e.g., short message service (SMS), WhatsApp messages, chats, etc., video and any type of interaction with customers 3.

ACD 26 may distribute incoming interactions 20 or tasks to agents 5 via agent terminals 6. Generally, ACD 26 may be a part of a switching system designed to receive incoming interactions 20 and queue them. In addition, ACD 26 may distribute the incoming interactions 20 to agents 5 or specific groups of agents 5 typically according to a prearranged scheme. In one embodiment, ACD 26 may be integrated with PBX switch 25, and may direct incoming interactions 20 to one of a plurality of agent terminals 6.

Generally, ACD 26 may receive incoming interactions 20 that may be handled by one of agents 5 at contact center 10. ACD 26 may connect an incoming interaction 20 to an appropriate agent 5 if agent 5 is available. If agent 5 is not available, the incoming interaction 20 may be held by ACD 26 until agent 5 becomes available. While an incoming interaction 20 is waiting for an agent 5, ACD 26 may collect data of the incoming interaction 20 or perform other automated processes. Once agent 5 is available, ACD 26 may route the incoming interaction 20 to agent 5.

In one embodiment, ACD 26 may be configured to perform skill-based routing, which may refer to routing incoming interactions 20 based on matching the skills required for handling the incoming interactions 20 and the skillset of agents 5. This may ensure that incoming interactions 20 may go to agents 5 with the correct skills to ensure a better contact experience. Skill-based routing may consider the unique skills of individual agents 5 and the preferences of individual customers 3 to route incoming interactions 20 to the most qualified or most appropriate agent 5.

When an incoming interaction 20 is received at ACD 26, the customer 3 may first be identified (e.g., via the contact's touch-tone entry of an account number or identification number, caller ID, or identification number associated with the customer 3), and a contact profile may be retrieved from a customer database. Agent information may be stored in agent database that may also be queried to determine which skills of the agents 5 match the preferences of the customer 3. Once a suitable agent 5 is identified, ACD 26 may route incoming interaction 20 to the appropriate agent 5 via the appropriate agent terminal 6.

Analysis center 50 may perform functions such as those shown in FIGS. 2-5, and may be implemented as software code and/or hardware for detecting manipulative content in interactions and evaluating trades based on the detected content, as disclosed herein. Analysis center 50 may communicate with contact center 10, and one or more agent terminals 6 and user terminals 8 to, for example, present work item 250 and interaction data (e.g., as presented in FIG. 7). Analysis center 50 may further communicate trade server 60, to obtain trade data 61 and to allow or block trade, as disclosed herein.

Reference is now made to FIG. 7 presenting an example of screenshot 700 of a graphical user interface displaying results of a method for detecting manipulative content in an interaction, according to embodiments of the present invention. Screenshot 700 may be generated based on the results of analysis performed for detecting manipulative content in interactions, for example, using data provided in work item 250 depicted in FIG. 2. Screenshot 700 may include a top section (header) 710 showing metadata of the interaction, including for example, the task or alerts the user is working on, with details like the alert type, owner, and alert date, etc., task identifiers such as business unit, issue ID, alert day (e.g., the date work item 250 has been created), and the business unit involved, identity of the participants in the interaction, duration of the interaction and the manipulation score (also referred to as alert score). Different or other metadata may be presented.

Screenshot 700 may include a main panel (middle section) presenting the conversation transcript 720, e.g., the text of the interaction, showing the dialogue between the participants (Chris and Rachel in this example). Each message may include timestamps and identification of the sender, e.g., the sender's email address. Words and phrases within the conversation that were identified as manipulative content may be highlighted 730 in different colors. These highlights are used to draw attention to specific parts of the text that may be important for analysis. For example;
“understand your concern” and “significant growth potential” might be highlighted to indicate persuasion or reassurance tactics.
“nervous” and “high-risk investment” are likely highlighted because they reflect Rachel's concerns or reservations about the investment.

A left sidebar 750 of screenshot 700 may present alert types and scores, e.g., shows different categories or types of alerts that have been triggered by the interaction, actions/tasks, e.g., icons representing various actions or tasks related to the alert, like collapsing sections or filtering the display.

A right sidebar 760 of screenshot 700 may present, for example:
The behavior patterns identified in the interaction, such as “Insider information.”
Selection labels: the criteria or filters applied to select this interaction for analysis.
Languages: the language used in the conversation, in this case, is “International English.”
Transcription date: the date and time when the interaction was transcribed.
Source instance and ID: these fields refer to where the interaction originated (e.g., a specific recording instance or file).
Total risk score: this is the overall risk score calculated from all the different factors, shown as “110” in this example.
Participant count: indicates the number of people involved in the interaction.

A bottom section 740 of screenshot 700 may present, for example:

An audio playback: an audio waveform and playback controls (e.g., play, pause, rewind), allowing the user to listen to the audio recording of the interaction while reviewing the transcript.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method for detecting manipulation in an interaction, the method comprising:
receiving text of the interaction;
analyzing the text of the interaction to detect manipulative content; and
generating a report summarizing the detected manipulative content.

2. The method of claim 1, wherein analyzing the text comprises checking for predefined patterns using a static dictionary.

3. The method of claim 1, wherein analyzing the text comprises performing dynamic analysis using a language model.

4. The method of claim 3, wherein analyzing the text comprises performing contextual analysis using the language model to provide a context-based explanation for why a certain content is manipulative.

5. The method of claim 3, wherein the language model comprises a bidirectional encoder representations from transformers (BERT) language model trained on a labeled dataset comprising text labeled as manipulative and text labeled as non-manipulative.

6. The method of claim 1, comprising generating a manipulation score based on the analysis.

7. The method of claim 6, comprising stopping the interaction if the manipulation score exceeds a threshold.

8. The method of claim 6, comprising generating an alert if the manipulation score exceeds a threshold.

9. The method of claim 1, comprising:
checking if a trade exists for an entity involved in the interaction; and
blocking the trade if the manipulation score exceeds a threshold.

10. The method of claim 1, comprising:
presenting the text of the interaction on a display; and
highlighting the manipulative content on the presented text.

11. A device comprising:
a memory; and
a processor configured to:
receive text of an interaction;
analyze the text of the interaction to detect manipulative content; and
generate a report summarizing the detected manipulative content.

12. The device of claim 11, wherein the processor is configured to analyze the text by checking for predefined patterns using a static dictionary.

13. The device of claim 11, wherein the processor is configured to analyze the text by performing dynamic analysis using a language model.

14. The device of claim 13, wherein the processor is configured to analyze the text by performing contextual analysis using the language model to provide a context-based explanation for why a certain content is manipulative.

15. The device of claim 13, wherein the language model comprises a bidirectional encoder representations from transformers (BERT) language model trained on a labeled dataset comprising text labeled as manipulative and text labeled as non-manipulative.

16. The device of claim 11, wherein the processor is configured to generate a manipulation score based on the analysis.

17. The device of claim 16, wherein the processor is configured to stop the interaction if the manipulation score exceeds a threshold.

18. The device of claim 16, wherein the processor is configured to generate an alert if the manipulation score exceeds a threshold.

19. The device of claim 11, wherein the processor is configured to:
check if a trade exists for an entity involved in the interaction; and
block the trade if the manipulation score exceeds a threshold.

20. The device of claim 19, wherein the processor is configured to:
present the text of the interaction on a display; and
highlight the manipulative content on the presented text.
